(19) United States
(12) Patent Application Publication
(10) Pub. No.: US 2026/0330101 A1
(43) Pub. Date: Oct. 22, 2026

(54) SYSTEM AND METHOD FOR SOFTWARE/HARDWARE ARCHITECTURE INTENT CONFIRMATION

(71) Applicant: TOYOTA JIDOSHA KABUSHIKI KAISHA, Aichi-Ken (JP)

(72) Inventor: Emily S. LERNER, Ann Arbor, MI (US)

(73) Assignee: TOYOTA JIDOSHA KABUSHIKI KAISHA, Aichi-Ken (JP)

(21) Appl. No.: 19/181,194

(22) Filed: Apr. 16, 2025

(51) Int. Cl. G06F 30/27; G06F 119/02

(52) U.S. Cl. CPC G06F 30/27; G06F 2119/02

(57) ABSTRACT

A method for architecture intent confirmation is described. The method includes determining an expected behavior of a designed vehicle component. The method also includes predicting, by a generative adversarial network (GAN), an actual behavior of the designed vehicle component according to previous design information. The method further includes determining whether the actual behavior is compatible with the expected behavior of the designed vehicle component. The method also includes suggesting a modification to the designed vehicle component to match the expected behavior of the designed vehicle component.

### BACKGROUND

### Field

Certain aspects of the present disclosure relate to autonomous vehicle technology and, more particularly, to a system and method for software/hardware architecture intent confirmation.

### BACKGROUND

Autonomous agents (e.g., vehicles, robots, etc.) rely on machine vision and sensors (inertial measurement unit (IMU) information, GPS, etc.) for estimating an agent's state (velocity, position, etc.) for sensing a surrounding environment by analyzing areas of interest in a scene from images of the surrounding environment. Autonomous agents, such as driverless cars and robots, are quickly evolving and have become a reality in this decade. The National Highway Traffic Safety Administration (“NHTSA”) has defined different “levels” of autonomous vehicles (e.g., Level 0, Level 1, Level 2, Level 3, Level 4, and Level 5). For example, if an autonomous vehicle has a higher-level number than another autonomous vehicle, then the autonomous vehicle with the higher-level number offers a greater combination and quantity of autonomous features relative to the other vehicle.

Autonomous driving (AD) as well as advanced driver assistance system (ADAS) technologies rely on various integrated components for operating a vehicle system. Presently, there may be basic documentation and architecture diagrams illustrating a manner in which systems are intended to operate such as, for example, operation of a vehicle system. Unfortunately, in a system that is very complex, such as a vehicle system equipped with an ADAS and/or AD technology, some elements may not be accurately represented. This is especially true in instances when many different development groups between different offices and countries work on different parts that are eventually integrated as part of a vehicle system. A solution for avoiding unexpected behaviors of designed components of vehicle systems that can cause many difficulties during development, is desired.

### SUMMARY

A method for architecture intent confirmation is described. The method includes determining an expected behavior of a designed vehicle component. The method also includes predicting, by a generative adversarial network (GAN), an actual behavior of the designed vehicle component according to previous design information. The method further includes determining whether the actual behavior is compatible with the expected behavior of the designed vehicle component. The method also includes suggesting a modification to the designed vehicle component to match the expected behavior of the designed vehicle component.

A non-transitory computer-readable medium having program code recorded thereon for architecture intent confirmation is described. The program code is executed by a processor. The non-transitory computer-readable medium includes program code to determine an expected behavior of a designed vehicle component. The non-transitory computer-readable medium also includes program code to predict, by a generative adversarial network (GAN), an actual behavior of the designed vehicle component according to previous design information. The non-transitory computer-readable medium further includes program code to determine whether the actual behavior is compatible with the expected behavior of the designed vehicle component. The non-transitory computer-readable medium also includes program code to suggest a modification to the designed vehicle component to match the expected behavior of the designed vehicle component.

A system for architecture intent confirmation is described. The system includes an expected behavior determination module to determine an expected behavior of a designed vehicle component. The system also includes a generative adversarial network (GAN) to predict an actual behavior of the designed vehicle component according to previous design information. The system further includes a behavior confirmation module to determine whether the actual behavior is compatible with the expected behavior of the designed vehicle component. The system also includes a behavior modification module a modification to the designed vehicle component to match the expected behavior of the designed vehicle component.

This has outlined, broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings, in which like reference characters identify correspondingly throughout.

FIG. 1 illustrates an example implementation using a system-on-a-chip (SOC) for a software/hardware architecture intent confirmation system, in accordance with aspects of the present disclosure.

FIG. 2 is a block diagram illustrating a software architecture that may modularize artificial intelligence (AI) functions for a software/hardware architecture intent confirmation system, according to aspects of the present disclosure.

FIG. 3 is a diagram illustrating an example of a hardware implementation for a software/hardware architecture intent confirmation system, according to aspects of the present disclosure.

FIGS. 4A and 4B are block diagrams illustrating a vehicle configured with a software/hardware architecture intent confirmation system, according to aspects of the present disclosure.

FIG. 5 illustrates a software/hardware architecture intent confirmation process for designed components of a vehicle system, according to various aspects of the present disclosure.

FIG. 6 is a flowchart illustrating a method for software/hardware architecture intent confirmation, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

Autonomous agents (e.g., vehicles, robots, etc.) rely on machine vision and sensors (IMU, GPS, etc.) for estimating an agent's state (velocity, position, etc.) for sensing a surrounding environment by analyzing areas of interest in a scene from images of the surrounding environment. Autonomous agents, such as driverless cars and robots, are quickly evolving and have become a reality in this decade. The National Highway Traffic Safety Administration (“NHTSA”) has defined different “levels” of autonomous vehicles (e.g., Level 0, Level 1, Level 2, Level 3, Level 4, and Level 5). For example, if an autonomous vehicle has a higher-level number than another autonomous vehicle, then the autonomous vehicle with the higher-level number offers a greater combination and quantity of autonomous features relative to the other vehicle.

Autonomous driving (AD) as well as advanced driver assistance system (ADAS) technologies rely on various integrated components for operating a vehicle system. Presently, there may be basic documentation and architecture diagrams illustrating a manner in which systems are intended to operate such as, for example, operation of a vehicle system. Unfortunately, in a system that is very complex, such as a vehicle system equipped with an ADAS and/or AD technology, some elements may not be accurately represented. This is especially true in instances when many different development groups between different offices and countries work on different parts that are eventually integrated as part of a vehicle system.

For example, an engineer may build a component for a particular purpose, such as to allocate memory from a register. Unfortunately, once built, the component may encounter unexpected difficulties, such as not having adequate memory space to allocate the register storage. This may happen within a broader system ecosystem, such as a vehicle system, in which many different systems interact, and many different groups work to develop the broader system. Without the capability to analyze the architecture in relation to the broader overall system for identifying possible hidden constraints, expected operation of the vehicle system is inhibited. A solution for avoiding unexpected behaviors of designed components of vehicle systems that can cause many difficulties during development, is desired.

Various aspects of the present disclosure are directed to a system and method for analyzing an architecture diagram for a component along with a stated intent/behavior of the designed component to identify problems within the design. In particular, a generative adversarial network (GAN), such as generative model in combination with a large language model (LLM) to provide suggestions, is implemented to accept and study the input for determining an expected behavior of a designed vehicle component. The model can assess whether the stated intent matches the expected intent and identify issues within the design that cause the disparity. This facilitates identifying hidden constraints within a broader codebase that can include various aspects that are unknown when developed by different groups in an organization.

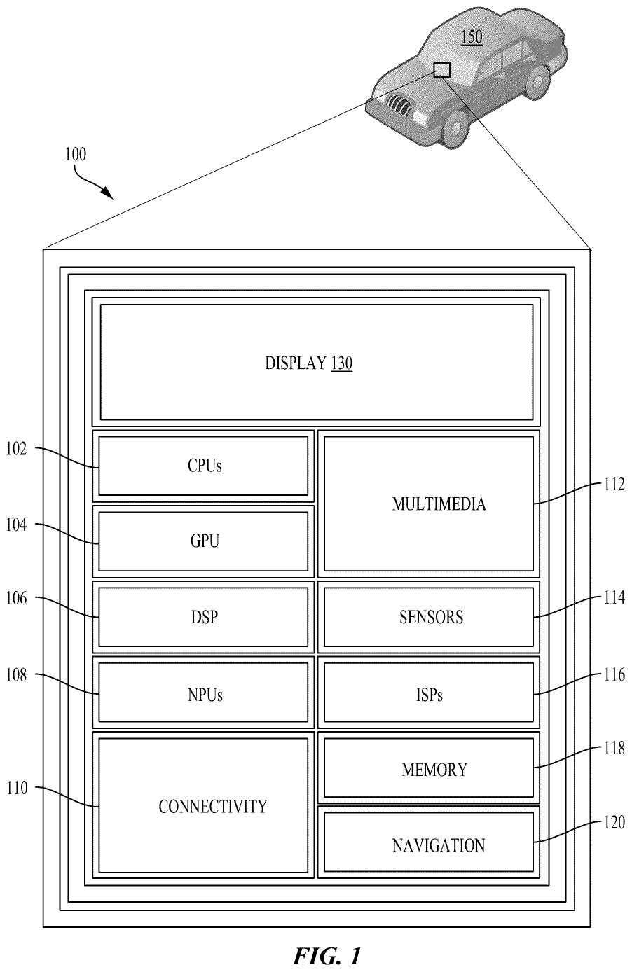

FIG. 1 illustrates an example implementation of the aforementioned system and method for a software/hardware architecture intent confirmation system using a system-on-a-chip (SOC) 100 of a vehicle 150. The SOC 100 may include a single processor or multicore processors (e.g., a central processing unit (CPU) 102), in accordance with certain aspects of the present disclosure. Variables, system parameters associated with a computational device, delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include sixth generation (6G) cellular network technology, fifth generation (5G) new radio (NR) technology, fourth generation long term evolution (4G LTE) connectivity, WiFi connectivity, USB connectivity, Bluetooth® connectivity, and the like. In addition, a multimedia processor 112 in combination with a display 130 may, for example, apply a temporal component of a current traffic state to select a vehicle safety action, according to the display 130 illustrating a view of a vehicle. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system (GPS).

The SOC 100 may be based on an Advanced Risc Machine (ARM) instruction set, RISC-V, or any reduced instruction set computing (RISC) architecture, or the like. In another aspect of the present disclosure, the SOC 100 may be a server computer in communication with the vehicle 150. In this arrangement, the vehicle 150 may include a processor and other features of the SOC 100. In this aspect of the present disclosure, instructions loaded into a processor (e.g., the CPU 102) or the NPU 108 of the vehicle 150 may include program code to perform software/hardware architecture intent confirmation. For example, a software/hardware architecture intent confirmation system is particularly useful for prediction of hidden constraints that could cause difficulties when integrated in a proposed system. In particular, the disclosed architecture intent confirmation system beneficially avoids unexpected behaviors of designed systems that can cause many difficulties during development.

The instructions loaded into a processor (e.g., the NPU 108) may also include program code to determine an expected behavior of a designed vehicle component. The instructions loaded into a processor (e.g., the NPU 108) may also include program code to predict, by a generative adversarial network (GAN), an actual behavior of the designed vehicle component according to previous design information. The instructions loaded into a processor (e.g., the NPU 108) may also include program code to determine whether the actual behavior is compatible with the expected behavior of the designed vehicle component. The instructions loaded into a processor (e.g., the NPU 108) may also include program code to suggest a modification to the designed vehicle component to match the expected behavior of the designed vehicle component.

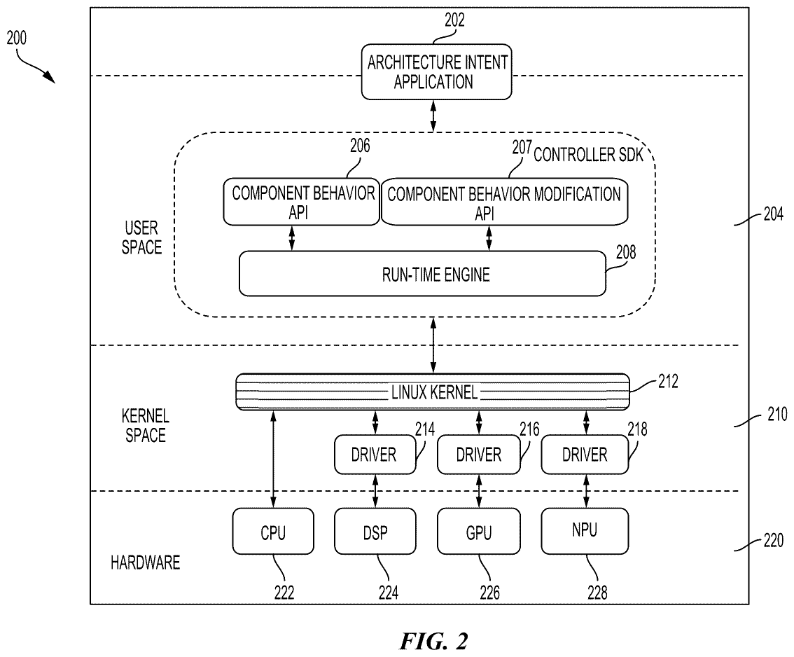

FIG. 2 is a block diagram illustrating a software architecture 200 that may modularize artificial intelligence (AI) functions for a software/hardware architecture intent confirmation system, according to aspects of the present disclosure. Using the software architecture 200, an architecture intent application 202 may be designed such that it may cause various processing blocks of a system-on-a-chip (SOC) 220 (e.g., a CPU 222, a DSP 224, a GPU 226, and/or an NPU 228) to perform supporting computations during run-time operation of the architecture intent application 202. While FIG. 2 describes the software architecture 200 for software/hardware architecture intent confirmation features, it should be recognized that the state estimation features are not limited to autonomous driving (AD). According to aspects of the present disclosure, the software/hardware architecture intent confirmation system is applicable to any design component integrated in a system.

The architecture intent application 202 may be configured to call functions defined in a user space 204 that may, for example, provide for software/hardware architecture intent confirmation for providing improved AD as well as advanced driver assistance systems (ADAS). The architecture intent application 202 is configured to analyze an architecture diagram for a designed component along with a stated intent/behavior of the designed component to identify problems within the designed component.

The architecture intent application 202 may make a request to compile program code associated with a library defined in a component behavior application programming interface (API) 206 to determine an expected behavior of a designed vehicle component. The component behavior API 206 may also utilize a generative adversarial network (GAN) to predict an actual behavior of the designed vehicle component according to previous design information. The component behavior API 206 may also determine whether the actual behavior is compatible with the expected behavior of the designed vehicle component. Additionally, a component behavior modification API 207 may suggest a modification to the designed vehicle component to match the expected behavior of the designed vehicle component.

A run-time engine 208, which may be compiled code of a runtime framework, may be further accessible to the architecture intent application 202. The architecture intent application 202 may cause the run-time engine 208, for example, to take actions for an intended behavior confirmation of a software/hardware architecture. When a conflicted between and expected and an actual behavior of the software/hardware architecture is detected, the run-time engine 208 may in turn send a signal to an operating system 210, such as a Linux Kernel 212, running on the SOC 220. FIG. 2 illustrates the Linux Kernel 212 as software architecture for suggesting a modification to match the behaviors. It should be recognized, however, that aspects of the present disclosure are not limited to this exemplary software architecture. For example, other kernels may be used to provide the software architecture to support the architecture intent confirmation functionality to any applications with integrated designed complements in a larger, complex system.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, a dynamic model may be configured to run on a combination of processing blocks, such as the CPU 222 and the GPU 226, or may be run on the NPU 228 if present.

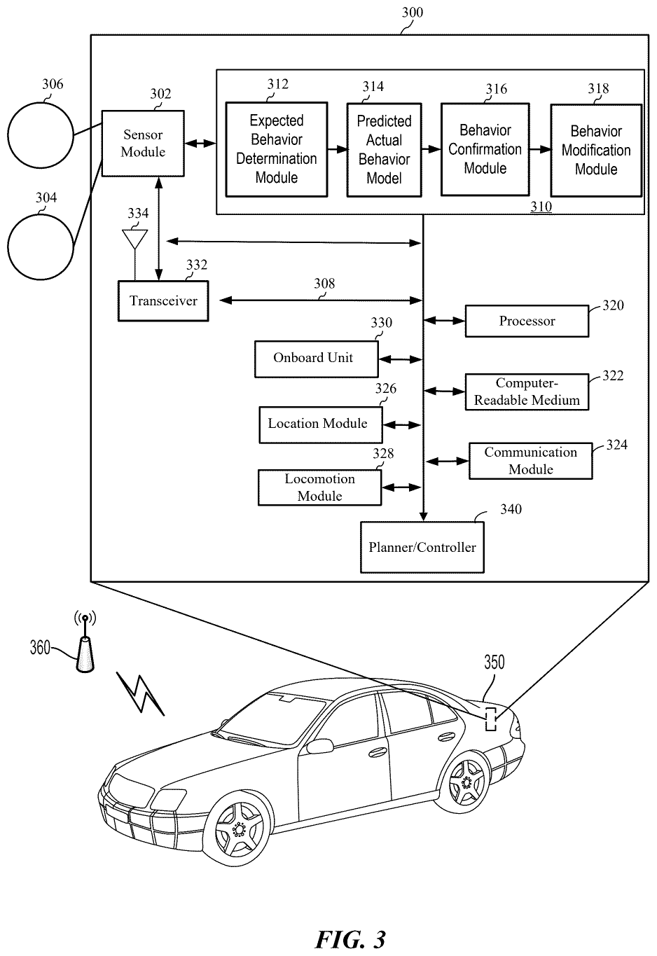

FIG. 3 is a diagram illustrating an example of a hardware implementation for a software/hardware architecture intent confirmation system 300, according to aspects of the present disclosure. The software/hardware architecture intent confirmation system 300 may be configured to provide for software/hardware architecture intent confirmation for providing improved autonomous driving (AD) as well as advanced driver assistance systems (ADAS) of a vehicle 350. The software/hardware architecture intent confirmation system 300 is configured to analyze an architecture diagram for a designed component along with a stated intent/behavior of the designed component to identify problems within the designed component. The software/hardware architecture intent confirmation system 300 may be a component of a vehicle or other non-autonomous device (e.g., non-autonomous vehicles). For example, as shown in FIG. 3, the software/hardware architecture intent confirmation system 300 is a component of the vehicle 350.

Aspects of the present disclosure are not limited to the software/hardware architecture intent confirmation system 300 being a component of the vehicle 350. Other devices, such as a bus, motorcycle, or other like non-autonomous vehicle, are also contemplated for implementing the software/hardware architecture intent confirmation system 300. In this example, the vehicle 350 may be autonomous or semi-autonomous; however, other configurations for the vehicle 350 are contemplated, such as an advanced driver assistance system (ADAS).

The software/hardware architecture intent confirmation system 300 may be implemented with an interconnected architecture, such as a controller area network (CAN) bus, represented by an interconnect 308. The interconnect 308 may include any number of point-to-point interconnects, buses, and/or bridges depending on the specific application of the software/hardware architecture intent confirmation system 300 and the overall design constraints. The interconnect 308 links together various circuits including one or more processors and/or hardware modules, represented by a sensor module 302, an architecture intent module 310, a processor 320, a computer-readable medium 322, a communication module 324, a location module 326, a locomotion module 328, an onboard unit 330, and a planner/controller 340. The interconnect 308 may also link various other circuits such as timing sources, peripherals, voltage regulators, and power management circuits, which are well known in the art, and therefore, will not be described further.

The software/hardware architecture intent confirmation system 300 includes a transceiver 332 coupled to the sensor module 302, the architecture intent module 310, the processor 320, the computer-readable medium 322, the communication module 324, the location module 326, the locomotion module 328, the onboard unit 330, and the planner/controller 340. The transceiver 332 is coupled to antenna 334. The transceiver 332 communicates with various other devices over a transmission medium. For example, the transceiver 332 may receive commands via transmissions from a user or a connected vehicle. In this example, the transceiver 332 may receive/transmit vehicle-to-vehicle traffic state information for the architecture intent module 310 to/from connected vehicles within the vicinity of the vehicle 350.

The software/hardware architecture intent confirmation system 300 includes the processor 320 coupled to the computer-readable medium 322. The processor 320 performs processing, including the execution of software stored on the computer-readable medium 322 to provide functionality according to the disclosure. The software, when executed by the processor 320, causes the software/hardware architecture intent confirmation system 300 to provide software/hardware architecture intent confirmation for providing improved autonomous driving (AD) as well as ADAS of the vehicle 350. The software/hardware architecture intent confirmation system 300 is configured to analyze an architecture diagram for a designed component along with a stated intent/behavior of the designed component to identify problems within the designed component. The computer-readable medium 322 may also be used for storing data that is manipulated by the processor 320 when executing the software.

The sensor module 302 may obtain measurements via different sensors, such as a first sensor 306 and a second sensor 304. The first sensor 306 may be a vision sensor (e.g., a stereoscopic camera or a red-green-blue (RGB) camera) for capturing 2D images of the vehicle operator. The second sensor 304 may be a ranging sensor, such as a light detection and ranging (LIDAR) sensor or a radio detection and ranging (RADAR) sensor for capturing an external vehicle environment. Of course, aspects of the present disclosure are not limited to the aforementioned sensors as other types of sensors (e.g., thermal, sonar, and/or lasers) are also contemplated for either of the first sensor 306 or the second sensor 304.

The measurements of the first sensor 306 and the second sensor 304 may be processed by the processor 320, the sensor module 302, the architecture intent module 310, the communication module 324, the location module 326, the locomotion module 328, the onboard unit 330, and/or the planner/controller 340. In conjunction with the computer-readable medium 322, the measurements of the first sensor 306 and the second sensor 304 are processed to implement the functionality described herein. In one configuration, the data captured by the first sensor 306 and the second sensor 304 may be transmitted to a connected vehicle via the transceiver 332. The first sensor 306 and the second sensor 304 may be coupled to the vehicle 350 or may be in communication with the vehicle 350.

The location module 326 may determine a location of the vehicle 350. For example, the location module 326 may use a global positioning system (GPS) to determine the location of the vehicle 350. The location module 326 may implement a dedicated short-range communication (DSRC)-compliant GPS unit. A DSRC-compliant GPS unit includes hardware and software to make the vehicle 350 and/or the location module 326 compliant with one or more of the following DSRC standards, including any derivative or fork thereof: EN 12253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

The communication module 324 may facilitate communications via the transceiver 332. For example, the communication module 324 may be configured to provide communication capabilities via different wireless protocols, such as 6G, 5G new radio (NR), WiFi, long term evolution (LTE), 4G, 3G, etc. The communication module 324 may also communicate with other components of the vehicle 350 that are not modules of the software/hardware architecture intent confirmation system 300. The transceiver 332 may be a communications channel through a network access point 360. The communications channel may include DSRC, 6G, 5G NR, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

In some configurations, the network access point 360 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communications, mmWave, Wi-Fi (infrastructure mode), Wi-Fi (ad-hoc mode), visible light communication, TV white space communication, and satellite communication. The network access point 360 may also include a mobile data network that may include 3G, 4G, 5G NR, 6G, LTE, LTE-V 2X, LTE-D 2D, VoLTE, or any other mobile data network or combination of mobile data networks. Further, the network access point 360 may include one or more IEEE 802.11 wireless networks.

The software/hardware architecture intent confirmation system 300 also includes the planner/controller 340 for planning a route and controlling the locomotion of the vehicle 350, via the locomotion module 328 for autonomous operation of the vehicle 350. In one configuration, the planner/controller 340 may override a user input when the user input is expected (e.g., predicted) to cause a collision according to an autonomous level of the vehicle 350. The modules may be software modules running in the processor 320, resident/stored in the computer-readable medium 322, and/or hardware modules coupled to the processor 320, or some combination thereof.

The National Highway Traffic Safety Administration (“NHTSA”) has defined different “levels” of autonomous vehicles (e.g., Level 0, Level 1, Level 2, Level 3, Level 4, and Level 5). For example, if an autonomous vehicle has a higher-level number than another autonomous vehicle (e.g., Level 3 is a higher-level number than Levels 2 or 1), then the autonomous vehicle with a higher-level number offers a greater combination and quantity of autonomous features relative to the vehicle with the lower-level number. These distinct levels of autonomous vehicles are described briefly below.

Level 0: In a Level 0 vehicle, the set of advanced driver assistance system (ADAS) features installed in a vehicle provide no vehicle control but may issue warnings to the driver of the vehicle. A vehicle which is Level 0 is not an autonomous or semi-autonomous vehicle.

Level 1: In a Level 1 vehicle, the driver is ready to take driving control of the autonomous vehicle at any time. The set of ADAS features installed in the autonomous vehicle may provide autonomous features such as: adaptive cruise control (“ACC”); parking assistance with automated steering; and lane keeping assistance (“LKA”) type II, in any combination.

Level 2: In a Level 2 vehicle, the driver is obliged to detect objects and events in the roadway environment and respond if the set of ADAS features installed in the autonomous vehicle fail to respond properly (based on the driver's subjective judgement). The set of ADAS features installed in the autonomous vehicle may include accelerating, braking, and steering. In a Level 2 vehicle, the set of ADAS features installed in the autonomous vehicle can deactivate immediately upon takeover by the driver.

Level 3: In a Level 3 ADAS vehicle, within known, limited environments (such as freeways), the driver can safely turn their attention away from driving tasks but is still be prepared to take control of the autonomous vehicle when needed.

Level 4: In a Level 4 vehicle, the set of ADAS features installed in the autonomous vehicle can control the autonomous vehicle in all but a few environments, such as severe weather. The driver of the Level 4 vehicle enables the automated system (which is comprised of the set of ADAS features installed in the vehicle) only when it is safe to do so. When the automated Level 4 vehicle is enabled, driver attention is not required for the autonomous vehicle to operate safely and consistent within accepted norms.

Level 5: In a Level 5 vehicle, other than setting the destination and starting the system, no human intervention is involved. The automated system can drive to any location where it is legal to drive and make its own decision (which may vary based on the district where the vehicle is located).

A highly autonomous vehicle (“HAV”) is an autonomous vehicle that is Level 3 or higher. Accordingly, in some configurations the vehicle 350 is one of the following: a Level 1 autonomous vehicle; a Level 2 autonomous vehicle; a Level 3 autonomous vehicle; a Level 4 autonomous vehicle; a Level 5 autonomous vehicle; and an HAV.

The architecture intent module 310 may be in communication with the sensor module 302, the processor 320, the computer-readable medium 322, the communication module 324, the location module 326, the locomotion module 328, the onboard unit 330, the transceiver 332, and the planner/controller 340. In one configuration, the architecture intent module 310 receives sensor data from the sensor module 302. The sensor module 302 may receive the sensor data from the first sensor 306 and the second sensor 304. According to aspects of the present disclosure, the sensor module 302 may filter the data to remove noise, encode the data, decode the data, merge the data, extract frames, or perform other functions. In an alternate configuration, the architecture intent module 310 may receive sensor data directly from the first sensor 306 and the second sensor 304 to determine, for example, input traffic data images.

Autonomous driving (AD) as well as advanced driver assistance system (ADAS) technologies rely on various integrated components for operating the vehicle 350. Presently, there may be basic documentation and architecture diagrams of how systems are intended to work such as, for example, operating the vehicle 350. Unfortunately, in a system that is very complex, such as the vehicle 350 equipped with an ADAS or AD technology, some elements may not be accurately represented. This is especially true in instances when many different development groups between different offices and countries work on different parts of the vehicle 350.

For example, an engineer may build a component for a particular purpose, such as to allocate memory from a register. Unfortunately, once built, the component may encounter unexpected difficulties, such as not having adequate memory space to allocate the register storage. This may happen within a broader system ecosystem, such as a vehicle system, in which many different systems interact, and many different groups work to develop the broader vehicle system. Without the capability to analyze the architecture in relation to the broader overall system for identifying possible hidden constraints, expected operation of the vehicle system is inhibited. A solution for avoiding unexpected behaviors of designed components of vehicle systems that can cause many difficulties during development, is desired.

Various aspects of the present disclosure are directed to a system and method for analyzing an architecture diagram for a component along with a stated intent/behavior of the designed component to identify problems within the design. In particular, generative adversarial network (GAN), such as a generative machine learning model in combination with an LLM to provide suggestions/summaries, is implemented to accept and study the input for determining an expected behavior of a designed vehicle component. The model can assess whether the stated intent matches the expected intent and identify issues within the design that cause the disparity. This facilitates identifying hidden constraints within a broader codebase that can include various aspects that are unknown when developed by different groups in an organization.

As shown in FIG. 3, the software/hardware architecture intent confirmation system 300 includes the architecture intent module 310 that includes an expected behavior determination module 312, a predicted actual behavior model 314, a behavior confirmation module 316, and a behavior modification module 318. The expected behavior determination module 312, the predicted actual behavior model 314, the behavior confirmation module 316, and/or the behavior modification module 318 may be implemented using a generative adversarial network (GAN). The architecture intent module 310 is not limited to a generative adversarial network (GAN).

The expected behavior determination module 312 is configured to determine an expected behavior of a designed vehicle component. The predicted actual behavior model 314 is configured to predict, by a generative adversarial network (GAN), an actual behavior of the designed vehicle component according to previous design information. The behavior confirmation module 316 is configured to determine whether the actual behavior is compatible with the expected behavior of the designed vehicle component. The behavior modification module 318 is configured to suggest a modification to the designed vehicle component to match the expected behavior of the designed vehicle component.

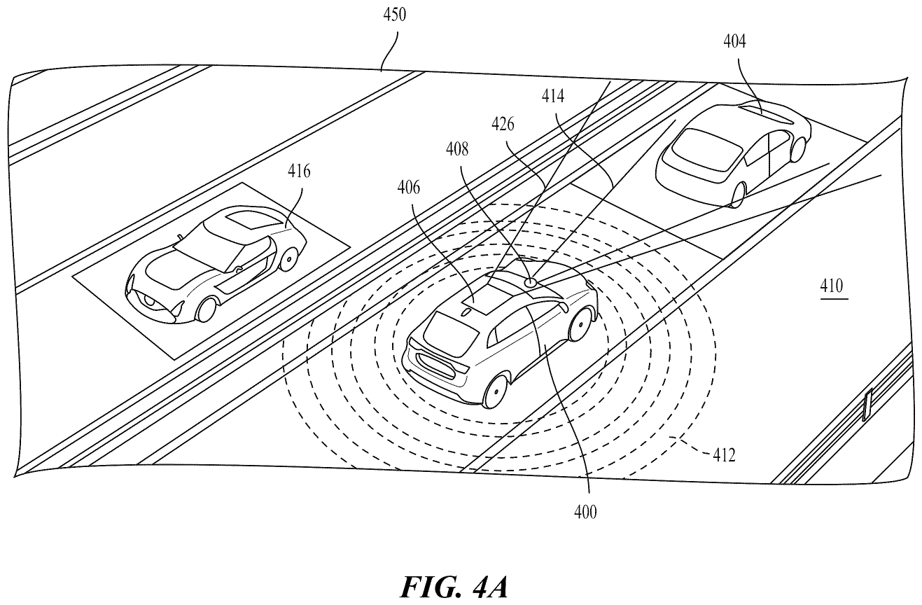

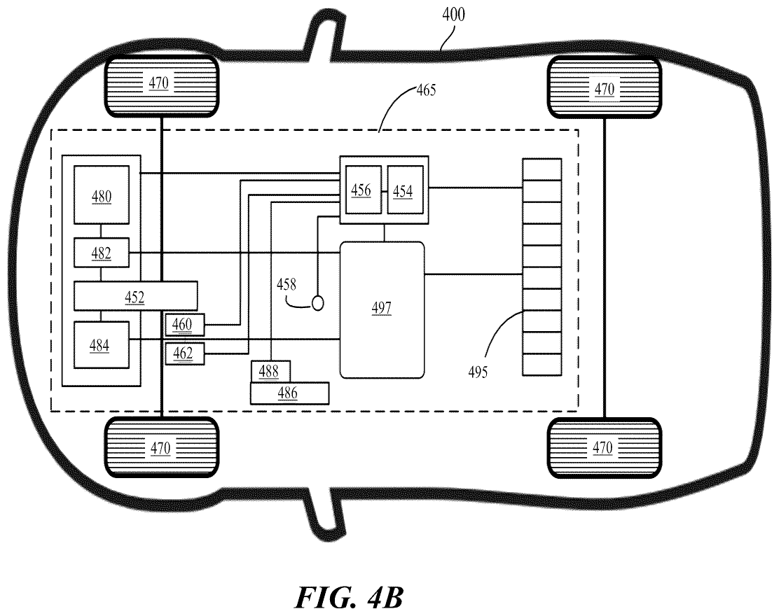

FIGS. 4A and 4B are block diagrams illustrating a vehicle configured with a software/hardware architecture intent confirmation system, according to aspects of the present disclosure.

FIG. 4A is a diagram illustrating an example of a vehicle 400 in an environment 450, in accordance with various aspects of the present disclosure. In the example of FIG. 4A, the vehicle 400 may be an autonomous vehicle, a semi-autonomous vehicle, or a non-autonomous vehicle. As shown in FIG. 4A, the vehicle 400 may be traveling on a road 410. A first vehicle 404 may be ahead of the vehicle 400 and a second vehicle 416 may be adjacent to the vehicle 400. In this example, the vehicle 400 may include a 2D camera 408, such as a 2D red-green-blue (RGB) camera, and a LIDAR sensor 406. The 2D camera 408 and the LIDAR sensor 406 may be components of an overall sensor system (e.g., the sensor module 302). Other sensors, such as radar and/or ultrasound, are also contemplated. Additionally, or alternatively, although not shown in FIG. 4A, the vehicle 400 may include one or more additional sensors, such as a camera, a radar sensor, and/or a LIDAR sensor, integrated with the vehicle in one or more locations, such as within one or more storage locations (e.g., a trunk). Additionally, or alternatively, although not shown in FIG. 4A, the vehicle 400 may include one or more force measuring sensors.

In one configuration, the 2D camera 408 captures a 2D image that includes objects in the 2D camera's 408 field of view 414. The LIDAR sensor 406 may generate one or more output streams. The first output stream may include a three-dimensional (3D) cloud point of objects in a first field of view, such as a 360° field of view 412 (e.g., bird's eye view). The second output stream 424 may include a 3D cloud point of objects in a second field of view, such as a forward-facing field of view, such as the 2D camera's 408 field of view 414 and/or the 2D sensor's 406 field of view 426.

The 2D image captured by the 2D camera 408 includes a 2D image of the first vehicle 404, as the first vehicle 404 is in the 2D camera's 408 field of view 414. As is known to those of skill in the art, a LIDAR sensor 406 uses laser light to sense the shape, size, and position of objects in an environment. The LIDAR sensor 406 may vertically and horizontally scan the environment. In the current example, the artificial neural network (e.g., autonomous driving system) of the vehicle 400 may extract height and/or depth features from the first output stream. In some examples, an autonomous driving system of the vehicle 400 may also extract height and/or depth features from the second output stream 424.

The information obtained from the LIDAR sensor 406 and the 2D camera 408 may be used to evaluate a driving environment. In some examples, the information obtained from the LIDAR sensor 406 and the 2D camera 408 may identify whether the vehicle 400 is at an intersection or a crosswalk. Additionally, or alternatively, the information obtained from the LIDAR sensor 406 and the 2D camera 408 may identify whether one or more dynamic objects, such as pedestrians, are near the vehicle 400.

FIG. 4B is a diagram illustrating an example of a vehicle 400, in accordance with various aspects of the present disclosure. It should be understood that various aspects of the present disclosure may be directed to an autonomous vehicle. The autonomous vehicle may be an internal combustion engine (ICE) vehicle, fully electric vehicle (EV), or another type of vehicle. The vehicle 400 may include drive force unit 465 and wheels 470. The drive force unit 465 may include an engine 480, motor generators (MGs) 482 and 484, a battery 495, an inverter 497, a brake pedal 486, a brake pedal sensor 488, a transmission 452, a memory 454, an electronic control unit (ECU) 456, a shifter 458, a speed sensor 460, and a gyroscopic sensor 462.

The engine 480 primarily drives the wheels 470. The engine 480 can be an ICE that combusts fuel, such as gasoline, ethanol, diesel, biofuel, or other types of fuels which are suitable for combustion. The torque output by the engine 480 is received by the transmission 452. The MGs 482 and 484 can also output torque to the transmission 452. The engine 480 and the MGs 482 and 484 may be coupled through a planetary gear (not shown in FIG. 4B). The transmission 452 delivers an applied torque to one or more of the wheels 470. The torque output by the engine 480 does not directly translate into the applied torque to the one or more wheels 470.

The MGs 482 and 484 can serve as motors which output torque in a drive mode and can serve as generators to recharge the battery 495 in a regeneration mode. The electric power delivered from or to the MGs 482 and 484 passes through the inverter 497 to the battery 495. The brake pedal sensor 488 can detect pressure applied to the brake pedal 486, which may further affect the applied torque to the wheels 470. The speed sensor 460 is connected to an output shaft of the transmission 452 to detect a speed input which is converted into a vehicle speed by the ECU 456. The gyroscopic sensor 462 is connected to the body of the vehicle 400 to detect the actual deceleration of the vehicle 400, which corresponds to a deceleration torque.

The transmission 452 may be a transmission suitable for any vehicle. For example, the transmission 452 can be an electronically controlled continuously variable transmission (ECVT), which is coupled to the engine 480 as well as to the MGs 482 and 484. The transmission 452 can deliver torque output from a combination of the engine 480 and the MGs 482 and 484. The ECU 456 controls the transmission 452, utilizing data stored in the memory 454 to determine the applied torque delivered to the wheels 470. For example, the ECU 456 may determine that at a certain vehicle speed, the engine 480 should provide a fraction of the applied torque to the wheels 470 while one or both of the MGs 482 and 484 provide most of the applied torque. The ECU 456 and the transmission 452 can control an engine speed (NE) of the engine 480 independently of the vehicle speed (V).

The ECU 456 may include circuitry to control the above aspects of vehicle operation. Additionally, the ECU 456 may include, for example, a microcomputer that includes one or more processing units (e.g., microprocessors), memory storage (e.g., RAM, ROM, etc.), and I/O devices. The ECU 456 may execute instructions stored in memory to control one or more electrical systems or subsystems in the vehicle 400. Furthermore, the ECU 456 can include one or more electronic control units such as, for example, an electronic engine control module, a powertrain control module, a transmission control module, a suspension control module, a body control module, and so on. As a further example, electronic control units may control one or more systems and functions such as doors and door locking, lighting, human-machine interfaces, cruise control, telematics, braking systems (e.g., anti-lock braking system (ABS) or electronic stability control (ESC)), or battery management systems, for example. These various control units can be implemented using two or more separate electronic control units, or a single electronic control unit.

The MGs 482 and 484 each may be a permanent magnet type synchronous motor including, for example, a rotor with a permanent magnet embedded therein. The MGs 482 and 484 may each be driven by an inverter controlled by a control signal from the ECU 456, so as to convert direct current (DC) power from the battery 495 to alternating current (AC) power and supply the AC power to the MGs 482 and 484. In some examples, a first MG 482 may be driven by electric power generated by a second MG 484. It should be understood that in embodiments where MGs 482 and 484 are DC motors, no inverter is required. The inverter 497, in conjunction with a converter assembly, may also accept power from one or more of the MGs 482 and 484 (e.g., during engine charging), convert this power from AC back to DC, and use this power to charge the battery 495 (hence the name, motor generator). The ECU 456 may control the inverter 497, adjust driving current supplied to the first MG 482, and adjust the current received from the second MG 484 during regenerative coasting and braking.

The battery 495 may be implemented as one or more batteries or other power storage devices including, for example, lead-acid batteries, lithium ion and nickel batteries, capacitive storage devices, and so on. The battery 495 may also be charged by one or more of the MGs 482 and 484, such as, for example, by regenerative braking or coasting, during which one or more of the MGs 482 and 484 operates as a generator. Alternatively, or additionally, the battery 495 can be charged by the first MG 482, for example, when the vehicle 400 is idle (not moving/not in drive). Further still, the battery 495 may be charged by a battery charger (not shown) that receives energy from the engine 480. The battery charger may be switched or otherwise controlled to engage/disengage it with the battery 495. For example, an alternator or generator may be coupled directly or indirectly to a drive shaft of the engine 480 to generate an electrical current as a result of the operation of the engine 480. Still other embodiments contemplate the use of one or more additional motor generators to power the rear wheels of the vehicle 400 (e.g., in vehicles equipped with 4-Wheel Drive), or using two rear motor generators, each powering a rear wheel.

The battery 495 may also power other electrical or electronic systems in the vehicle 400. In some examples, the battery 495 can include, for example, one or more batteries, capacitive storage units, or other storage reservoirs suitable for storing electrical energy that can be used to power one or both of the MGs 482 and 484. When the battery 495 is implemented using one or more batteries, the batteries can include, for example, nickel metal hydride batteries, lithium-ion batteries, lead acid batteries, nickel cadmium batteries, lithium-ion polymer batteries, or other types of batteries.

The vehicle 400 may operate in one of an autonomous mode, a manual mode, or a semi-autonomous mode. In the manual mode, a human driver manually operates (e.g., controls) the vehicle 400. In the autonomous mode, an autonomous control system (e.g., autonomous driving system) operates the vehicle 400 without human intervention. In the semi-autonomous mode, the human may operate the vehicle 400, and the autonomous control system may override or assist the human. For example, the autonomous control system may override the human to prevent a collision or to obey one or more traffic rules.

As noted above, autonomous driving (AD) as well as advanced driver assistance system (ADAS) technologies rely on various integrated components for operating the vehicle 400. Presently, there may be basic documentation and architecture diagrams of how systems are intended to work such as, for example, operating the vehicle 400. Unfortunately, in a system that is very complex, such as the vehicle 350 equipped with an ADAS or AD technology, some elements may not be accurately represented. This is especially true in instances when many different development groups between different offices and countries work on different parts of the vehicle 400.

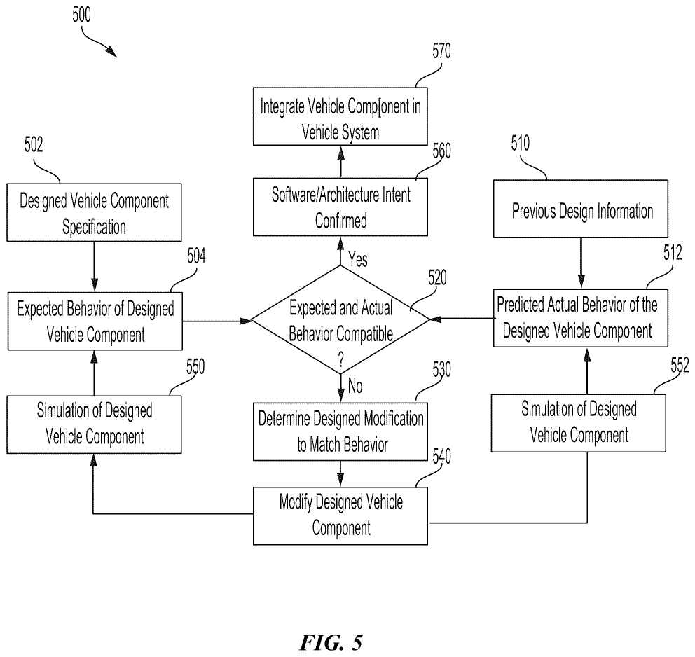

For example, an engineer may build a component for a particular purpose, such as to allocate memory from a register. Unfortunately, once built, the component may encounter unexpected difficulties, such as not having adequate memory space to allocate the register storage. This may happen within a broader system ecosystem, such as a vehicle system of the vehicle 400, in which many different systems interact, and many different groups work to develop the broader vehicle system. Without the capability to analyze the architecture in relation to the broader overall system for identifying possible hidden constraints, expected operation of the vehicle system of the vehicle 400 is inhibited. A solution for avoiding unexpected behaviors of designed components of vehicle systems that can cause many difficulties during development is illustrated, for example, in FIG. 5.

FIG. 5 illustrates a software/hardware architecture intent confirmation process 500 for designed components of a vehicle system, according to various aspects of the present disclosure. As shown in FIG. 5, the software/hardware architecture intent confirmation process 500 begins by determining an expected behavior of a designed vehicle component at block 504. In this example, the expected vehicle behavior is determined at block 504 based on a designed vehicle component specification provided at block 502. Alternatively, the expected vehicle behavior is determined at block 504 based on simulation of the designed vehicle component at block 502. Alternatively, the expected behavior of the designed vehicle component is determined by analyzing an architecture diagram for the designed vehicle component.

As further illustrated in FIG. 5, at block 512, a generative adversarial network (GAN) predicts an actual behavior of the designed vehicle component according to previous design information at 510. At block 520, it is determined whether the actual behavior is compatible with the expected behavior of the designed vehicle component. According to various aspects of the present disclosure, when an incompatibility is detected, at block 530, a modification to the designed vehicle component to match the expected behavior of the designed vehicle component is determined. At block 540, the desired vehicle component is modified.

According to various aspects of the present disclosure, once modified at block 540, simulation of the designed vehicle component may be performed at block 550, followed by determining of the expected vehicle behavior at block 504. Similarly, simulation of the designed vehicle component may be performed at block 552, followed by predicting of the expected vehicle behavior at block 512. Predicting includes simulating operation of the designed vehicle component at block 512, while integrated in a vehicle system according to the previous design information of the vehicle system from block 510. Analyzing the simulated operation of the designed vehicle component is performed to determine the actual behavior of the designed vehicle component. Control then returns to block 520 until compatible behavior is detected.

According to various aspects of the present disclosure, the designed vehicle component may be a powertrain, a brake electronic control unit (ECU), and/or an advanced driver assistance system (ADAS). Additionally, the previous design information may include a schematic describing the designed vehicle component. In some implementations, determining of compatible vehicle behavior at block 520 involves verifying the designed vehicle component described in an electronic schematic is compatible with a codebase. Alternatively, the previous design information includes an architecture diagram of the designed vehicle component and a codebase in which to integrate the designed vehicle component.

In some implementations, incompatible vehicle behavior is overcome by modifying the designed vehicle component to match the expected behavior of the designed vehicle component. Once the expected behavior matches the predicted behavior at block 520, at block 560, a software/hardware architecture intent is confirmed. In this implementation, at block 570, the modification process further involves integrating the modified designed vehicle component in a vehicle, such as the vehicle 400, as shown in FIGS. 4A and 4B.

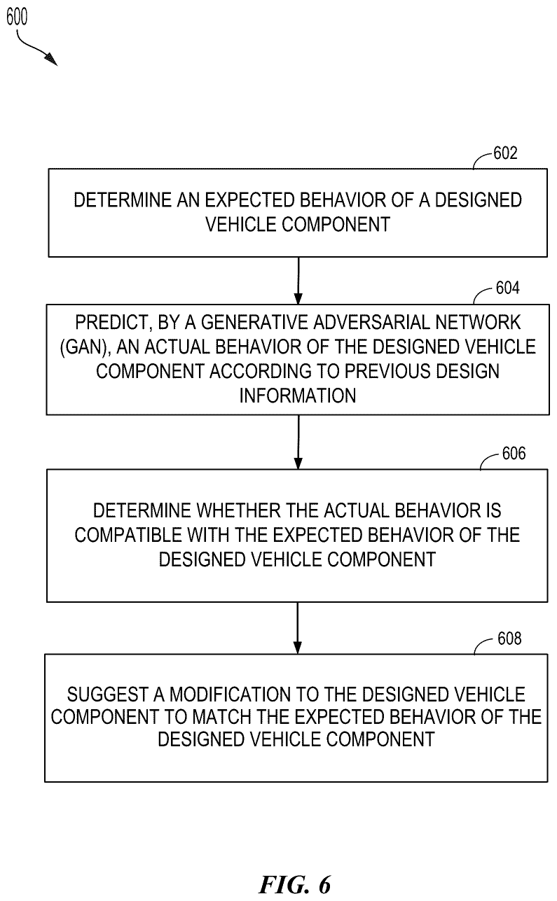

Analysis of the designed vehicle component may involve access matrix laboratory (MATLAB) descriptions of the designed vehicle component. Additionally, simulation of the designed vehicle component may be performed using Simulink or other like environment for modeling, simulating, and analyzing a vehicle system. Additionally, this analysis may involve state transition diagrams, flow charts, state transition tables, and truth tables. In some implementations, physical component models based on physical connections that directly integrate with block diagrams and other modeling paradigms of the designed vehicle component as well as the vehicle system, such as electric motors, bridge rectifiers, hydraulic actuators, and refrigeration systems, by assembling fundamental components into a schematic. Additionally, unified modeling language (UML) may be utilized to visualize the design of the vehicle component and/or the vehicle system. A method for software/hardware architecture intent confirmation is shown, for example, in FIG. 6.

FIG. 6 is a flowchart illustrating a method for architecture intent confirmation, according to aspects of the present disclosure. A method 600 beings at block 602, in which an expected behavior of a designed vehicle component is determined. For example, as shown in FIG. 5, the software/hardware architecture intent confirmation process 500 begins by determining an expected behavior of a designed vehicle component at block 504. In this example, the expected vehicle behavior is determined at block 504 based on a designed vehicle component specification provided at block 502. Alternatively, the expected vehicle behavior is determined at block 504 based on simulation of the designed vehicle component at block 502. Alternatively, the expected behavior of the designed vehicle component is determined by analyzing an architecture diagram for the designed vehicle component.

At block 604, a generative adversarial network (GAN) predicts an actual behavior of the designed vehicle component according to previous design information. At block 606, it is determined whether the actual behavior is compatible with the expected behavior of the designed vehicle component. At block 606, a modification to the designed vehicle component is suggested to match the expected behavior of the designed vehicle component. For example, as further illustrated in FIG. 5, at block 512, a generative adversarial network (GAN) predicts an actual behavior of the designed vehicle component according to previous design information at 510. At block 520, it is determined whether the actual behavior is compatible with the expected behavior of the designed vehicle component. According to various aspects of the present disclosure, when an incompatibility is detected, at block 530, a modification to the designed vehicle component to match the expected behavior of the designed vehicle component is determined. At block 540, the desired vehicle component is modified.

In some aspects of the present disclosure, the method shown in FIG. 6 may be performed by the SOC 100 (FIG. 1) or the software architecture 200 (FIG. 2) of the vehicle 150. That is, each of the elements or methods may, for example, but without limitation, be performed by the SOC 100, the software architecture 200, the processor (e.g., CPU 102), and/or other components included therein of the vehicle 150, or the software/hardware architecture intent confirmation system 300.

The various operations of the methods described above may be performed by any suitable means capable of performing the corresponding functions. The means may include various hardware and/or software component(s) and/or module(s), including, but not limited to, a circuit, an application specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in numerous ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and nonlinear model predictive control described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc, where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for architecture intent confirmation, the method comprising:
determining an expected behavior of a designed vehicle component;
predicting, by a generative adversarial network (GAN), an actual behavior of the designed vehicle component according to previous design information;
determining whether the actual behavior is compatible with the expected behavior of the designed vehicle component; and
suggesting a modification to the designed vehicle component to match the expected behavior of the designed vehicle component.

2. The method of claim 1, in which predicting comprises:
simulating operation of the designed vehicle component integrated in a vehicle system according to the previous design information of the vehicle system; and
analyzing the simulating operation of the designed vehicle component to determine the actual behavior of the designed vehicle component.

3. The method of claim 2, in which the designed vehicle component comprises a powertrain.

4. The method of claim 2, in which the designed vehicle component comprises a brake electronic control unit (ECU).

5. The method of claim 2, in which the designed vehicle component comprises an advanced driver assistance system (ADAS).

6. The method of claim 1, in which the previous design information comprises a schematic describing the designed vehicle component.

7. The method of claim 1, in which determining comprises verifying the designed vehicle component described in an electronic schematic is compatible with a codebase.

8. The method of claim 1, in which the previous design information comprises an architecture diagram of the designed vehicle component and a codebase in which to integrate the designed vehicle component.

9. The method of claim 1, further comprising modifying the designed vehicle component to match the expected behavior of the designed vehicle component.

10. The method of claim 9, further comprising integrating the designed vehicle component in a vehicle after the modifying.

11. A non-transitory computer-readable medium having program code recorded thereon for architecture intent confirmation, the program code being executed by a processor and comprising:
program code to determine an expected behavior of a designed vehicle component;
program code to predict, by a generative adversarial network (GAN), an actual behavior of the designed vehicle component according to previous design information;
program code to determine whether the actual behavior is compatible with the expected behavior of the designed vehicle component; and
program code to suggest a modification to the designed vehicle component to match the expected behavior of the designed vehicle component.

12. The non-transitory computer-readable medium of claim 11, in which the program code to predict comprises:
program code to simulate operation of the designed vehicle component integrated in a vehicle system according to the previous design information of the vehicle system; and
program code to analyze the program code to simulate operation of the designed vehicle component to determine the actual behavior of the designed vehicle component.

13. The non-transitory computer-readable medium of claim 12, in which the designed vehicle component comprises a powertrain, a brake electronic control unit (ECU), and/or an advanced driver assistance system (ADAS).

14. The non-transitory computer-readable medium of claim 11, in which the previous design information comprises a schematic describing the designed vehicle component.

15. The non-transitory computer-readable medium of claim 11, in which the program code to determine comprises program code to verify the designed vehicle component described in an electronic schematic is compatible with a codebase.

16. The non-transitory computer-readable medium of claim 11, in which the previous design information comprises an architecture diagram of the designed vehicle component and a codebase in which to integrate the designed vehicle component.

17. The non-transitory computer-readable medium of claim 11, further comprising:
program code to modify the designed vehicle component to match the expected behavior of the designed vehicle component; and
program code to integrate the designed vehicle component in a vehicle after the modifying.

18. A system for architecture intent confirmation, the system comprising:
an expected behavior determination module to determine an expected behavior of a designed vehicle component;
a generative adversarial network (GAN) to predict an actual behavior of the designed vehicle component according to previous design information;
a behavior confirmation module to determine whether the actual behavior is compatible with the expected behavior of the designed vehicle component; and
a behavior modification module a modification to the designed vehicle component to match the expected behavior of the designed vehicle component.

19. The system of claim 18, in which the designed vehicle component comprises a powertrain, a brake electronic control unit (ECU), and/or an advanced driver assistance system (ADAS).

20. The system of claim 18, in which the behavior modification module is further modify the designed vehicle component to match the expected behavior of the designed vehicle component, and to integrate the designed vehicle component in a vehicle after the modifying.
